(19) United States
(12) Patent Application Publication
(10) Pub. No.: US 2021/0060512 A1
(43) Pub. Date: Mar. 4, 2021

(54) METHODS, SYSTEMS, AND APPARATUS FOR ENCAPSULATING A SEQUESTRATION MEDIUM

(71) Applicant: THE TRUSTEES OF COLUMBIA UNIVERSITY IN THE CITY OF NEW YORK, New York, NY (US)

(72) Inventors: Ah-Hyung Alissa PARK, New York, NY (US); Qiao LIN, New York, NY (US); Dongyang WANG, New York, NY (US); Wei YU, New York, NY (US); Ming GAO, New York, NY (US); Guanhe RIM, New York, NY (US); Tony FERIC, New York, NY (US)

(73) Assignee: THE TRUSTEES OF COLUMBIA UNIVERSITY IN THE CITY OF NEW YORK, New York, NY (US)

(21) Appl. No.: 17/083,686

(22) Filed: Oct. 29, 2020

Related U.S. Application Data
(63) Continuation of application No. PCT/US2019/029907, filed on Apr. 30, 2019.
(60) Provisional application No. 62/814,520, filed on Mar. 6, 2019.
(60) Provisional application No. 62/664,625, filed on Apr. 30, 2018.

(51) Int. Cl. B01J 13/14; B01J 13/20; B01J 20/28; B01J 20/22; B01J 20/26; B01J 20/30

(52) U.S. Cl. CPC B01J 13/14; B01J 13/206; B01J 20/28021; B01J 20/3085; B01J 20/261; B01J 20/262; B01J 20/226

(57) ABSTRACT

An apparatus for encapsulating a material includes a first channel in fluid communication with a source of a material for encapsulation, at least one second channel in fluid communication with a source of a photopolymerizable compound, and at least one third channel in fluid communication with a source of an encapsulating fluid. Flow of the photopolymerizable compound into the first channel produces sheath flow in the first channel such that the material is within the polymerizable compound. Addition of the encapsulating fluid produces encapsulation precursors. Upon irradiation via a UV-radiation source, the photopolymerizable compound in the encapsulation precursor forms a polymer shell encapsulating the material for encapsulation. Materials such as nanoparticle organic hybrid materials (NOHMs) and a metal-organic frameworks (MOFs) can be thus encapsulated as carbon sequestration micro particles, as the polymer shell is permeable by gases such as carbon dioxide but selectively rejects other compounds such as water.

### CROSS REFERENCE TO RELATED APPLICATION(S)

This application is a continuation of International Patent Application No. PCT/US2019/029907, filed Apr. 30, 2019, which claims the benefit of U.S. Provisional Application Nos. 62/664,625, filed Apr. 30, 2018, and 62/814,520, filed Mar. 6, 2019, which are incorporated by reference as if disclosed herein in their entireties.

### STATEMENT REGARDING FEDERALLY SPONSORED RESEARCH OR DEVELOPMENT

This invention was made with government support under 1509760 awarded by the National Science Foundation, and DK101085 awarded by the National Institutes of Health. The government has certain rights in the invention.

### BACKGROUND

The continued rise of greenhouse gas emissions has made carbon capture technology an important technological development in the 21st century. Current systems for capturing carbon are plagued by high capital, energy and chemical costs. Post-combustion capture of carbon dioxide is currently the most effective method of carbon capture from gas emissions. Typically, aqueous solvents are employed to absorb carbon dioxide (CO₂) from the emissions. However, this method requires a large amount of energy input to evaporate the water phase of the solution for solvent regeneration.

Non-aqueous solvents such as ionic liquids, CO₂-binding organic liquids, and nanoparticle organic hybrid materials (NOHMs) have been developed to reduce the energy requirement. NOHMs have excellent thermal stability, near zero vapor pressure, and high chemical tenability, but have a high viscosity which hampers their practical application. Micro encapsulation of carbon capture solvent using high CO₂ permeable polymers provides a possible solution to address this issue. However, conventional micro encapsulations of carbon capture solvent are produced by a double-capillary device, which is not only difficult to fabricate and replicate but also skill-required in practice. Additionally, UV-curable silicone elastomer with a high CO₂ permeability is a potential shell material for encapsulations of NOHMs. But the wetting properties do not favor droplets of silicone elastomer in PDMS micro channels, which hinders application of normal PDMS microfluidics devices.

One of the other interesting and promising solid sorbents developed for CO₂ capture are Metal-Organic Frameworks (MOFs), whose properties can be controlled by tuning the chemical blocks of their crystalline unit. MOFs are porous crystalline materials including metal clusters or ions acting as connecting nodes, and rigid organic bridging ligands. MOFs are one of the most studied and advanced sorbent materials developed over the last five years for CO₂ capture. More than 300,000 MOFs have been simulated by many researchers trying to find the right chemistries and structures for CO₂ capture, e.g., from industrial and energy-producing sources. While MOFs could be “best in class” for carbon capture, there are still challenges, e.g., they have weak water tolerance, and cannot be simply deployed in a large-scale fixed bed CO₂ capture unit due to very high pressure drop and attendant problems of handling fine particulate matter.

Further, the conventional ways of MOF synthesis via hydrothermal or solvothermal reactions are often time-consuming, e.g., several hours to days. A number of MOFs have been successfully synthesized by creating macro-droplets containing metallic salts and organic ligand dissolved in a polar medium. For example, the synthesis time of HKUST-1 is reduced from two weeks to as short as 12 minutes. Once synthesized, MOFs are separated, washed using ethanol, and dried. While this study is very interesting, the final product is still fine MOF powder, which requires further processing before its application for gas separation.

While the properties of MOFs are indeed important, one of the very important questions that has not been answered yet is how to deploy them in a CO₂ capture system. A number of particulate systems including MOFs are either nanoparticles of ultrafine particles. The direct use of these particles is difficult and hazardous in any reactor systems or environment, (e.g., high pressure drops) and risks (e.g., emission of fine particulates). Various methods have been developed to allow an easier delivery of MOFs, such as grafting on other adsorbents (e.g. zeolite), shaping MOFs into granules, pellets, and thin films, and incorporation of MOFs in a membrane system. Most of these approaches involve the direct contact of MOFs with flue gas. While the mass transfer would be best if MOFs are directly exposed to the flue gas stream, contact with flue gasses also leads to chemical degradation of MOFs.

### SUMMARY

Some embodiments of the present disclosure are directed to an apparatus for encapsulating a material including a first channel in fluid communication with a source of a material for encapsulation, at least one second channel in fluid communication with a source of a photopolymerizable compound, the at least one second channel also in fluid communication with the first channel and positioned at an angle to the first channel so as to produce sheath flow in the first channel wherein the material is within the polymerizable compound, at least one third channel in fluid communication with a source of an encapsulating fluid, the at least one third channel also in fluid communication with the first channel and positioned downstream of the at least one second channel, and a UV-radiation source configured to irradiate the photopolymerizable compound to produce an encapsulated material.

In some embodiments, the UV-radiation source is positioned downstream of the third channel and configured to irradiate the photopolymerizable compound within the first channel to produce a polymer shell. In some embodiments, the encapsulated material includes two or more material cores within the polymer shell. In some embodiments, the material includes a carbon sequestration medium, explosive compound, crystal structure, or combinations thereof In some embodiments, the carbon sequestration medium includes a nanoparticle organic hybrid material, a metal-organic framework, or combinations thereof. In some embodiments, the metal-organic framework includes HKUST-1, MOF-5, IRMOF-3, UiO-66, or combinations thereof. In some embodiments, the polymer shell is permeable to CO₂. In some embodiments, the photopolymerizable compound includes a siloxane, polyimide, polyethersulfone, polyvinyl difluoride, or combinations thereof In some embodiments, encapsulating fluid is glycerol, polyvinyl alcohol, or combinations thereof In some embodiments, the first, at least one second, and at least one third channels are cast from polydimethylsiloxane via a soft lithography process. In some embodiments, the first channel has a first diameter upstream of the second channel and a second diameter downstream of the second channel, wherein the second diameter is greater than the first diameter. In some embodiments, the first channel has a first diameter upstream of the third channel and a second diameter downstream of the third channel, wherein the second diameter is greater than the first diameter.

Some embodiments of the present disclosure are directed to a method for encapsulating a material includes preparing a fluid including a material, flowing a stream of the material fluid through a first channel, combining the material fluid stream with a photopolymerizable compound fluid stream to produce a sheath flow in the first channel wherein the material fluid stream is within the photopolymerizable compound fluid stream, combining the sheath flow with an encapsulating fluid to produce one or more encapsulation precursors having an amount of material fluid separated from the encapsulating fluid by an amount of photopolymerizable compound fluid, and polymerizing photopolymerizable compound of the one or more encapsulation precursors via UV-radiation to produce an encapsulated material.

In some embodiments, the method includes heating the encapsulated material to remove solvent from the material fluid. In some embodiments, the method includes pulsing the material fluid stream to produce two or more material cores within the amount of photopolymerizable compound fluid once combined with the encapsulating fluid.

Some embodiments of the present disclosure are directed to a method of sequestering carbon dioxide including providing a device including a first channel in fluid communication with a source of a carbon sequestration medium for encapsulation, at least one second channel in fluid communication with a source of a photopolymerizable compound, the at least one second channel also in fluid communication with the first channel and positioned at an angle to the first channel, at least a third channel in fluid communication with a source of encapsulating fluid, the at least one third channel also in fluid communication with the first channel and positioned downstream of the second channel, and a UV-radiation source. In some embodiments, the method includes flowing the carbon sequestration medium from the source of a carbon sequestration medium through the first channel. In some embodiments, the method includes flowing the photopolymerizable compound from the source of a photopolymerizable compound through the second channel to surround the carbon sequestration medium and create a sheath flow with the carbon sequestration medium in an inner phase and the photopolymerizable compound as a middle phase. In some embodiments, the method includes combining the sheath flow with the encapsulating fluid to encapsulate the photopolymerizable compound middle phase in an encapsulating fluid outer phase. In some embodiments, the method includes polymerizing the photopolymerizable compound via the UV-radiation source to encapsulate the carbon sequestration medium in a polymer shell, wherein the polymer shell is permeable to CO₂. In some embodiments, the method includes administering an amount of a feed gas including CO₂ to sequester the CO₂ in the carbon sequestration medium.

### BRIEF DESCRIPTION OF THE DRAWINGS

The drawings show embodiments of the disclosed subject matter for the purpose of illustrating the invention. However, it should be understood that the present application is not limited to the precise arrangements and instrumentalities shown in the drawings, wherein:

FIG. 1 is a schematic drawing of an apparatus for encapsulating a material according to some embodiments of the present disclosure;

FIG. 2A is a schematic drawing of an encapsulation according to some embodiments of the present disclosure;

FIG. 2B is a schematic drawing of an encapsulation according to some embodiments of the present disclosure;

FIG. 3 is a chart of a method for encapsulating a material according to some embodiments of the present disclosure;

FIG. 4 is a flowchart of a process of forming an encapsulation according to some embodiments of the present disclosure; and

FIG. 5 is a chart of a method for encapsulating a material according to some embodiments of the present disclosure.

### DETAILED DESCRIPTION

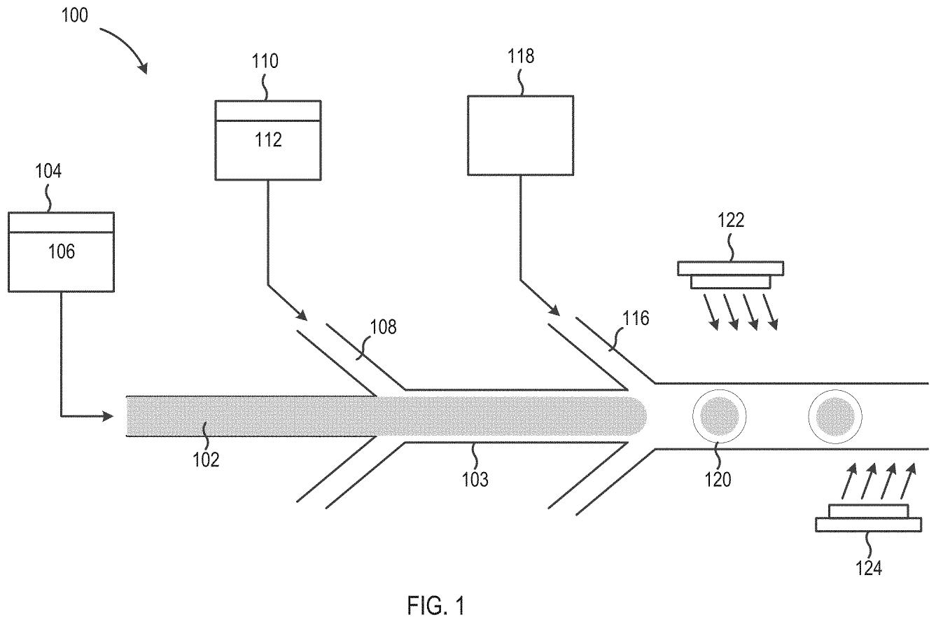

Referring now to FIG. 1, some aspects of the disclosed subject matter include an apparatus 100 for encapsulating a material. In some embodiments, apparatus 100 includes a first channel 102 configured to facilitate fluid flow through the apparatus. In some embodiments, the flow path of first channel 102 is generally planar. In some embodiments, fluid flow through first channel 102 transports the material or a material precursor for encapsulation through and/or by one or more features facilitating the encapsulation. In some embodiments, first channel 102 is incorporated into a single body 103. In some embodiments, apparatus 100 includes two or more bodies 103 (embodiment not shown), across which the one or more features facilitating encapsulation are distributed. First channel 102 can be of any suitable size and shape for use with the material to be encapsulated. In some embodiments, first channel 102 has a substantially constant flow diameter. In some embodiments, the diameter of first channel 102 is variable along a length the first channel, as will be discussed in greater detail below.

In some embodiments, first channel 102 is in fluid communication with a source of material 104. In some embodiments, the material for encapsulation includes a target sequestration medium, explosive compound, crystal structure, or combinations thereof In some embodiments, the target sequestration medium is a carbon and/or carbon compound sequestration medium. In some embodiments, the carbon sequestration medium includes a nanoparticle organic hybrid material (NOHM), NOHM compound, a metal-organic framework (MOFs), MOF compound, or combinations thereof In some embodiments, the metal-organic framework includes HKUST-1, MOF-5, IRMOF-3, UiO-66, or combinations thereof. In some embodiments, source of material 104 includes a solution 106 including an amount of the material. In some embodiments, solution 106 is itself the material. In some embodiments, solution 106 is a material precursor solution, e.g., a MOF precursor solution. In some embodiments, solution 106 is configured to flow from source 104 through apparatus 100 via first channel 102.

In some embodiments, apparatus 100 includes at least one second channel 108 in fluid communication with first channel 102. In some embodiments, second channel 108 is in fluid communication with a source 110 of a photopolymerizable compound. In some embodiments, source 110 includes a solution 112 including an amount of the photopolymerizable compound. In some embodiments, solution 112 is itself the photopolymerizable compound. In some embodiments, the photopolymerizable compound includes a siloxane, polyimide, polyethersulfone, polyvinyl difluoride, or combinations thereof In some embodiments, the photopolymerizable compound is permeable to a sequestration target, e.g., CO₂, at least upon polymerization, as will be discussed in greater detail below.

In some embodiments, second channel 108 is positioned and configured so as to produce sheath flow in first channel 102 upon addition of fluid from the second channel to the first channel. In some embodiments, the sheath flow has the material, e.g., solution 106, within the photopolymerizable compound., e.g., solution 112. In some embodiments, second channel 108 intersects first channel 102 at an angle Θ_{S}, e.g., at a junction 114. In some embodiments, Θ_{S} is between about 20° and about 40°. In some embodiments, Θ_{S} is about 30°. In some embodiments, the flow path of second channel 108 is annular to the flow path through first channel 102.

In some embodiments, apparatus 100 includes at least one third channel 116 in fluid communication first channel 102. In some embodiments third channel 116 is in fluid communication with a source 118 of an encapsulating fluid. In some embodiments, the encapsulating fluid is glycerol, polyvinyl alcohol, or combinations thereof In some embodiments, third channel 116 is positioned downstream of second channel 108. In some embodiments, third channel 116 intersects first channel 102 at an angle Θ_{T}, e.g., at a junction 114. In some embodiments, Θ_{T} is between about 20° and about 90°. In some embodiments, Θ_{T} is about 30°. In some embodiments, third channel 116 is positioned and configured to produce one or more encapsulation precursors 120 upon delivery of encapsulating fluid to first channel 102. In some embodiments, encapsulation precursor 120 include an amount of solution 106 separated from the encapsulating fluid by an amount of solution 112. In some embodiments, first channel 102 has a first diameter upstream of third channel 116 and a second diameter downstream of the third channel, with the second diameter being greater than the first diameter.

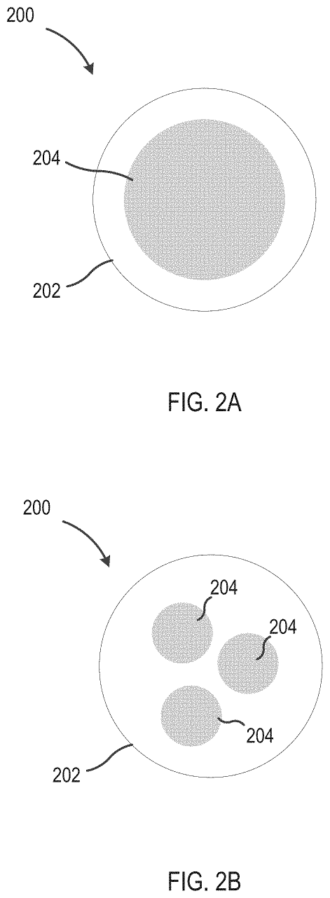

In some embodiments, apparatus 100 includes a UV-radiation source 122 configured to irradiate the photopolymerizable compound. In some embodiments, UV-radiation source 122 configured to irradiate the photopolymerizable compound is configured to irradiate encapsulation precursor 120, thus polymerizing the photopolymerizable compound therein and producing an encapsulated material. Referring now to FIG. 2A, in some embodiments, irradiating the photopolymerizable compound in encapsulation precursor 120 produces an encapsulation 200 having a polymer shell 202 surrounding the material core 204. In some embodiments, polymer shell 202 is permeable to a sequestration target, i.e., one or more molecules, compounds, etc. that are candidates for removal from the environment via sequestration, e.g., pollutants, that can be bound by the material for sequestration within encapsulation 200. In some embodiments, the sequestration target is carbon or a carbon compound, e.g., CO₂, hereinafter referred to collectively as “carbon.” In some embodiments, encapsulations 200 have diameters between about 10 μm to about 3 mm. In some embodiments, encapsulations 200 have diameters between about 200 μm to about 2 mm. Referring now to FIG. 2B, in some embodiments, encapsulation 200 includes two or more material cores 204 within the polymer shell 202. In some embodiments, encapsulation 200 is a porous solids or hollow. In some embodiments, the sizes of encapsulations 200 are tuned by altering the flow rates of fluids within first channel 102, second channel 108, and third channel 116.

Referring again to FIG. 1, in some embodiments, UV-radiation source 122 is positioned downstream of third channel 116 and configured to irradiate encapsulation precursor 120 within first channel 102. In some embodiments, a heat source 124 is positioned to heat encapsulations produced via apparatus 100. In some embodiments, heat source 124 is positioned downstream of UV-radiation source 122. In some embodiments, heat source 124 is positioned to heat the encapsulations with first channel 102. In some embodiments, heat source 124 provides sufficient heat to remove some or all solvent from within the encapsulations. In some embodiments, apparatus 100 includes any pumps, syringes, tubing, power sources, etc. to facilitate flow throughout the apparatus.

In some embodiments, apparatus 100 is produced via a soft lithography process. In some embodiments, at least first channel 102, second channel 108, and third channel 116 are produced via the soft lithography process. In these embodiments, components of apparatus 100 are cast from suitable polymeric material. In some embodiments, at least first channel 102, second channel 108, and third channel 116 is formed from polydimethylsiloxane via soft lithography.

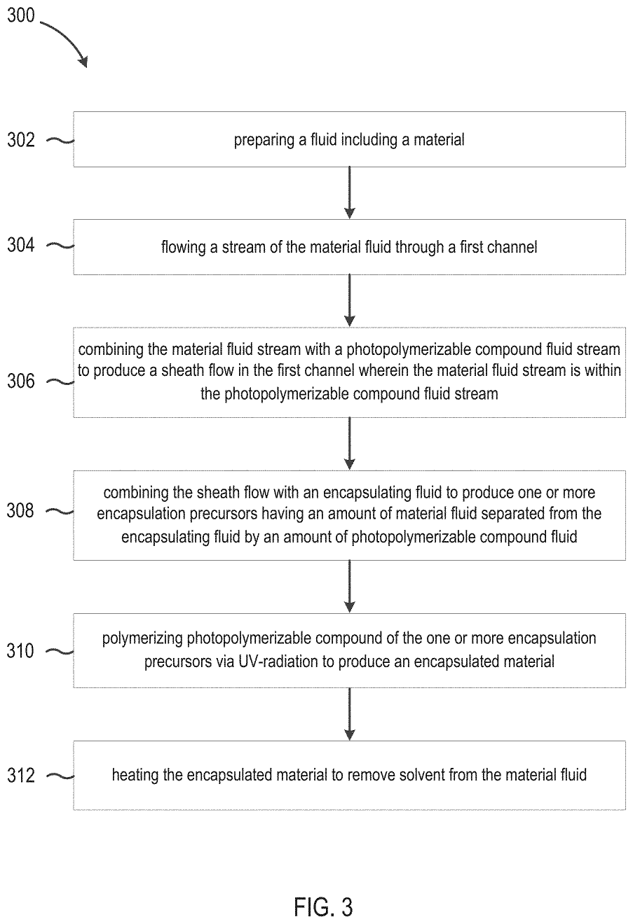

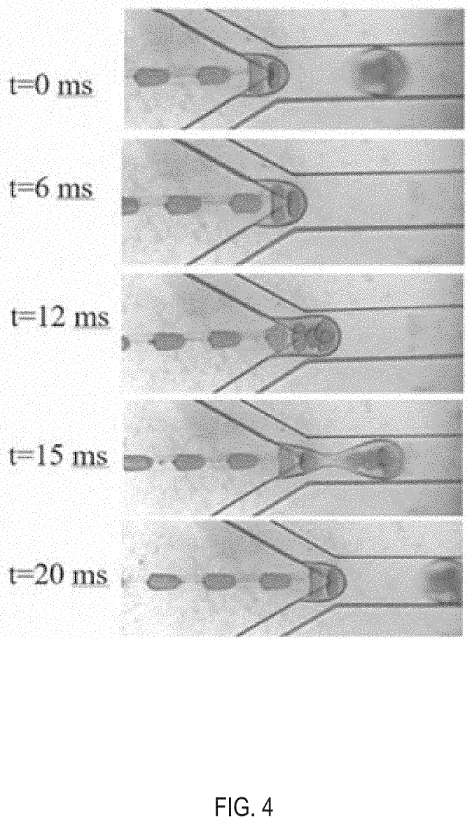

Referring now to FIG. 3, some embodiments of the present disclosure are directed to a method 300 for encapsulating a material, e.g., a carbon sequestration medium, explosive compound, crystal structure, or combination thereof. At 302, a fluid including a material is prepared. At 304, a stream of the material fluid is flowed through a first channel. At 306, the material fluid stream is combined with a photopolymerizable compound fluid stream to produce a sheath flow in the first channel wherein the material fluid stream is within the photopolymerizable compound fluid stream. At 308, the sheath flow is combined with an encapsulating fluid, e.g., an encapsulating fluid stream, to produce one or more encapsulation precursors. As discussed above, in some embodiments, the encapsulation precursors have an amount of material fluid separated from the encapsulating fluid by an amount of photopolymerizable compound fluid. In some embodiments, the material fluid stream is pulsed. Referring now to FIG. 4, pulsing the material fluid stream results in two or more material cores within the amount of photopolymerizable compound fluid once combined with the encapsulating fluid. Referring again to FIG. 3, at 310, the photopolymerizable compound of the one or more encapsulation precursors is polymerized to a polymer shell, e.g., via UV-radiation, to produce an encapsulation including the material. At 312, the encapsulated material is heated to remove solvent, e.g., from the material fluid in the encapsulation.

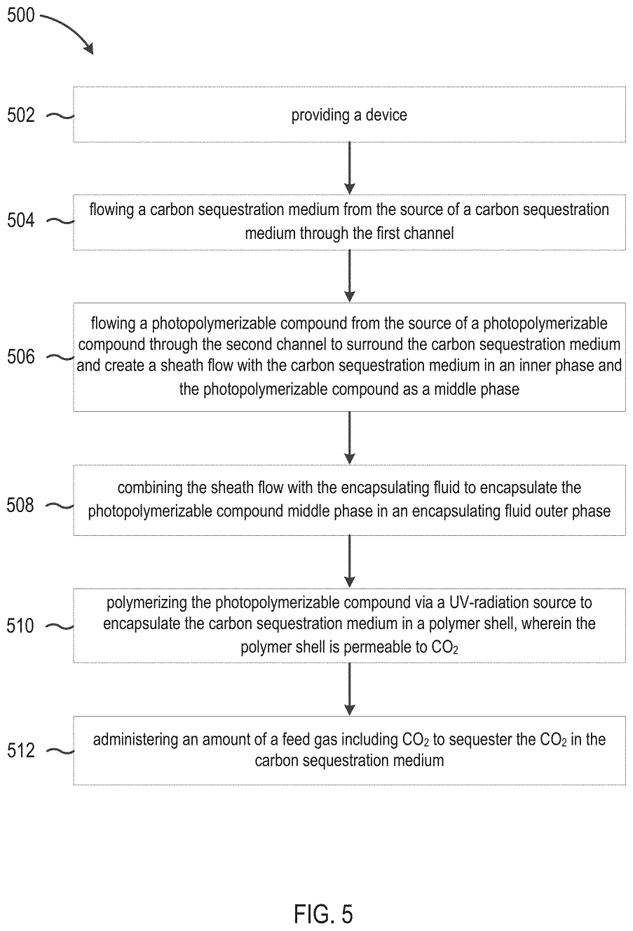

Referring now to FIG. 5, some embodiments of the present disclosure are directed to a method 500 of sequestering a sequestration target. In some embodiments, the sequestration target is a compound included in an effluent, e.g., flue gas. At 502, a device is provided that includes a first channel in fluid communication with a source of a target sequestration medium for encapsulation, at least one second channel in fluid communication with a source of a photopolymerizable compound, and at least a third channel in fluid communication with a source of encapsulating fluid. As discussed above, in some embodiments, the target sequestration medium is a carbon sequestration medium. As discussed above, in some embodiments, the device is at least in part provided via a soft lithography process, e.g., by casting the first, second, and third channels. At 504, the target sequestration medium is flowed from the source of a target sequestration medium through the first channel. At 506, the photopolymerizable compound is flowed from the source of a photopolymerizable compound through the second channel to surround the target sequestration medium and create a sheath flow with the target sequestration medium in an inner phase and the photopolymerizable compound as a middle phase. At 508, the sheath flow is combined with the encapsulating fluid to encapsulate the photopolymerizable compound middle phase in an encapsulating fluid outer phase. At 510, the photopolymerizable compound is polymerized via a UV-radiation source to encapsulate the target sequestration medium in a polymer shell. As discussed above, in some embodiments, the polymer shell is permeable to the sequestration target, e.g., CO₂, and the target sequestration medium is capable of sequestering the target. At 512, an amount of a feed gas including the sequestration target is administered to sequester the target in the sequestration medium. In some embodiments, the feed gas is an effluent or waste gas. In some embodiments, the feed gas includes CO₂.

Systems and methods of the present disclosure are advantageous to quickly and reliably produce microfluidic devices for the production of encapsulated materials. The soft lithography methods can produce these devices with ease and at large quantities, which is appealing for industrial applications. The devices then also provide an environment for simplified encapsulation of desired materials within microcapsules, including control over the composition of the microcapsules, the number of material cores within them, and mechanical robustness. In these embodiments, the multi-core encapsulations show higher capture kinetics than single core capsules. Such control is particularly advantageous for the creation of carbon sequestration materials. Firstly, the systems and methods of the present disclosure facilitate in-situ generation of sequestration materials within a polymer shell. Further, the sequestration materials, such as NOHMs and MOFs, are simply and reliably encapsulated in microcapsules having a shell permeable to target gases for sequestration, such as CO₂, while selectively rejecting other compounds such as water. Finally, the resulting encapsulation show longer-term stability in terms of mechanical robustness to improve the overall chemical and thermal stability. The encapsulations produced via the systems and methods of the present disclosure in CO2 capture reactors that have been designed for conventional CO₂ capture, e.g., for both coal and natural gas power production. Since the encapsulations have easily collectable particle sizes, they may also be directly injected into a duct system eliminating the need for a separate capture unit allowing potential reduction in the capital and operating costs.

Although the disclosed subject matter has been described and illustrated with respect to embodiments thereof, it should be understood by those skilled in the art that features of the disclosed embodiments can be combined, rearranged, etc., to produce additional embodiments within the scope of the invention, and that various other changes, omissions, and additions may be made therein and thereto, without parting from the spirit and scope of the present invention.

What is claimed is:

1. An apparatus for encapsulating a material comprising:
a first channel in fluid communication with a source of a material for encapsulation;
at least one second channel in fluid communication with a source of a photopolymerizable compound, the at least one second channel also in fluid communication with the first channel and positioned at an angle to the first channel so as to produce sheath flow in the first channel wherein the material is within the polymerizable compound;
at least one third channel in fluid communication with a source of an encapsulating fluid, the at least one third channel also in fluid communication with the first channel and positioned downstream of the at least one second channel; and
a UV-radiation source configured to irradiate the photopolymerizable compound to produce an encapsulated material.

2. The apparatus according to claim 1, wherein the material includes a carbon sequestration medium, explosive compound, crystal structure, or combinations thereof

3. The apparatus according to claim 2, wherein the carbon sequestration medium includes a nanoparticle organic hybrid material, a metal-organic framework, or combinations thereof.

4. The apparatus according to claim 3, wherein the metal-organic framework includes HKUST-1, MOF-5, IRMOF-3, UiO-66, or combinations thereof.

5. The apparatus according to claim 4, wherein the polymer shell is permeable to CO₂.

6. The apparatus according to claim 1, wherein encapsulating fluid is glycerol, polyvinyl alcohol, or combinations thereof.

7. The apparatus according to claim 1, wherein the first, at least one second, and at least one third channels are cast from polydimethylsiloxane via a soft lithography process.

8. An apparatus for encapsulating a material comprising:
a first channel in fluid communication with a source of a material for encapsulation;
at least one second channel in fluid communication with a source of a photopolymerizable compound, the at least one second channel also in fluid communication with the first channel and positioned at an angle to the first channel so as to produce sheath flow in the first channel wherein the material is within the polymerizable compound;
at least one third channel in fluid communication with a source of an encapsulating fluid, the at least one third channel also in fluid communication with the first channel and positioned downstream of the at least one second channel;
a UV-radiation source configured to irradiate the photopolymerizable compound to produce an encapsulated material, wherein the UV-radiation source is positioned downstream of the third channel and configured to irradiate the photopolymerizable compound within the first channel to produce a polymer shell; and
a heat source positioned downstream of the UV-radiation source. wherein the first channel has a first diameter upstream of the third channel and a second diameter downstream of the third channel, wherein the second diameter is greater than the first diameter.

9. The apparatus according to claim 8, wherein the photopolymerizable compound includes a siloxane, polyimide, polyethersulfone, polyvinyl difluoride, or combinations thereof

10. The apparatus according to claim 8, wherein the material includes a carbon sequestration medium, explosive compound, crystal structure, or combinations thereof.

11. A method for encapsulating a material comprising:
preparing a fluid including a carbon sequestration medium;
flowing a stream of the carbon sequestration medium fluid;
combining the carbon sequestration medium fluid stream with a photopolymerizable compound fluid stream to produce a sheath flow wherein the carbon sequestration medium fluid stream is within the photopolymerizable compound fluid stream;
combining the sheath flow with an encapsulating fluid to produce one or more encapsulation precursors having an amount of carbon sequestration medium fluid separated from the encapsulating fluid by an amount of photopolymerizable compound fluid; and
polymerizing photopolymerizable compound of the one or more encapsulation precursors via UV-radiation to produce an encapsulated material.

12. The method according to claim 11, further comprising heating the encapsulated material to remove solvent from the carbon sequestration medium fluid.

13. The method according to claim 11, further comprising pulsing the carbon sequestration medium fluid stream to produce two or more material cores within the amount of photopolymerizable compound fluid once combined with the encapsulating fluid.

14. The method according to claim 11, wherein the photopolymerizable compound is permeable to CO₂.

15. The method according to claim 14, wherein encapsulating fluid is glycerol, polyvinyl alcohol, or combinations thereof.

16. An composition comprising:
a plurality of micro-encapsulations, the micro-encapsulations including:
a carbon sequestration medium; and
a gas-permeable photopolymerized compound shell,
wherein the photopolymerized shell is formed by:
combining a carbon sequestration medium fluid stream with a photopolymerizable compound fluid stream to produce a sheath flow wherein the carbon sequestration medium fluid stream is within the photopolymerizable compound fluid stream;
combining the sheath flow with an encapsulating fluid to produce one or more encapsulation precursors having an amount of carbon sequestration medium fluid separated from the encapsulating fluid by an amount of photopolymerizable compound fluid; and
polymerizing photopolymerizable compound of the one or more encapsulation precursors via UV-radiation to produce the micro-encapsulations.

17. The composition according to claim 16, wherein the carbon sequestration medium includes a nanoparticle organic hybrid material, a metal-organic framework, or combinations thereof.

18. The composition according to claim 17, wherein the metal-organic framework includes HKUST-1, MOF-5, IRMOF-3, UiO-66, or combinations thereof.

19. The composition according to claim 16, wherein the micro-encapsulations include two or more carbon sequestration medium cores within the gas-permeable photopolymerized compound shell.

20. The composition according to claim 16, wherein the gas-permeable photopolymerized compound shell includes a siloxane, polyimide, polyethersulfone, polyvinyl difluoride, or combinations thereof.
